(19) United States
(12) Patent Application Publication
(10) Pub. No.: US 2006/0272764 A1
(43) Pub. Date: Dec. 7, 2006

(54) Enhanced Gypsum Wallboard

(76) Inventor: William P. Smith, Winston-Salem, NC (US)

Correspondence Address: SUMMA, ALLAN & ADDITON, P.A., 11610 NORTH COMMUNITY HOUSE ROAD, SUITE 200, CHARLOTTE, NC, 28277, US

(21) Appl. No.: 11/421,182

(22) Filed: May 31, 2006

Related U.S. Application Data
(60) Provisional application No. 60/686,561, filed on Jun. 2, 2005.

(51) Int. Cl. C04B 28/14; B32B 29/00

(52) U.S. Cl. 156/204; 106/772; 106/778; 428/703; 428/537.7

(57) ABSTRACT

An aqueous composition useful in forming a gypsum wallboard core possessing superior strength to weight ratio is provided. The composition includes calcium sulfate, water, and up to about 1.0 weight percent of a polyvinyl acetate emulsion, which typically includes less than about six weight percent polyvinyl alcohol. The aqueous composition is preferably substantially free of supplemental polyvinyl alcohol.

### CROSS-REFERENCE TO COMMONLY ASSIGNED APPLICATION

This application hereby claims the benefit of commonly assigned U.S. Provisional Patent Application Ser. No. 60/686,561, for Enhanced Gypsum Wallboard, filed Jun. 2, 2005. This application incorporates by reference this provisional application in its entirety.

### BACKGROUND OF THE INVENTION

The present invention relates to gypsum wallboard having high strength to weight ratio. More particularly, the invention relates to gypsum wallboard compositions having high strength to weight ratio and methods for making such compositions.

Panels of gypsum wallboard, which have a core of set gypsum sandwiched between two sheets of facing paper, have long been used as structural members in the fabrication of buildings. Such panels are typically used to form the partitions or walls of rooms, elevator shafts, stairwells, ceilings, and the like.

A typical manufacturing process for gypsum wallboard includes dispersing a gypsum slurry onto a moving sheet of facing material (i.e., facer) that is supported by equipment, such as forming tables, support belts, carrier rolls, and the like. A second sheet of facer fed from a roll onto the top of the slurry sandwiches the slurry between two moving facers. Forming or shaping equipment compresses the slurry to the desired thickness and the gypsum slurry is allowed to set, at least partially. After setting, sequential lengths of board are cut, then further processed by exposure to heat to remove excess water from the gypsum slurry. Heat accelerates the drying of the board by increasing the evaporation rate.

Conventional gypsum wallboard has many advantages, such as its low cost and easy workability in many construction applications. A major drawback of conventional wallboard, however, is its weight. Typical gypsum wallboard is approximately ½ inch thick and has a weight of between about 1650 to 1800 pounds per 1000 square feet of material (i.e., pounds MSF). “MSF,” material square feet, is a standard abbreviation in the art for a thousand square feet and is an area measurement for boxes, corrugated media, and wallboard.

This heavy weight, coupled with size of typical sheets (4′×8′ to 4′×16′), makes conventional wallboard both cumbersome and awkward to carry and manipulate. This is especially evident when gypsum wallboard is used in ceiling applications, because the individual sheets must be supported over the installer's head by hand or by some appropriate mechanical technique until nails (or other appropriate fasteners) can be employed to secure the wallboard. Not surprisingly, it is known in the art that handling bulky wallboard sheets exposes workers to potential hazards and increases the risk of occupational injury. Moreover, the weight of gypsum wallboard utilized in ceiling applications often causes the installed ceiling to sag.

Additionally, the heavy weight of conventional wallboard leads to shipping problems. The amount of wallboard that can be sent by truck or ship is limited by weight, not by space.

Patents and technical literature are replete with attempts to formulate lightweight wallboard compositions without sacrificing strength. An industry measure for acceptable strength of wallboard is the force required for the board to be pulled over the head of the nail, commonly referred to as the “nail-pull test.” These attempts to reduce wallboard density, however, often resulted in the addition of substantial manufacturing or material costs to the finished products. Additionally, the resultant wallboard often lacked the necessary strength for use in wall and ceiling applications.

One additive utilized in the industry for increasing gypsum wallboard strength while reducing wallboard density is polyvinyl alcohol (PVA). Those having ordinary skill in the art will appreciate that no monomer exists for polyvinyl alcohol. Thus, polyvinyl alcohol is obtained by the hydrolysis (or alcoholysis) of polyvinyl acetate (PVAC) with methanol. Both acids and bases catalyze the reaction, but base is usually employed because of better reaction rates and freedom from side reactions.

U.S. Pat. No. 3,853,689, to Morrone, teaches the inclusion of between about 0.150 and 0.4 parts polyvinyl alcohol per 100 parts gypsum stucco in an aqueous slurry that is used to form a gypsum core. The preferred polyvinyl alcohol is 80 percent hydrolyzed, resulting in a polyvinyl acetate content of between about 19.5 and 21.5 percent by weight of the polyvinyl alcohol content.

Other patents teach the use of polyvinyl alcohol as an additive useful in increasing the strength of gypsum wallboard. The conversion of polyvinyl acetate to polyvinyl alcohol, however, adds cost and reduces the efficiency of the wallboard manufacturing process. Additionally, the polyvinyl alcohol typically cannot be added to the wallboard composition in a powdered form. Rather, it must be placed in solution before it is incorporated. As those having ordinary skill in the art will appreciate, this additional burdensome step would hinder manufacturing efficiency.

U.S. Pat. No. 4,042,409, to Terada, discloses the use of polymer emulsions in a water repellent gypsum composition. The composition includes gypsum, a paraffin wax emulsion, and a polymer emulsion (i.e., a polyvinyl acetate emulsion). The Terada '409 patent requires the presence of the paraffin wax emulsion in the gypsum wallboard composition to achieve the desired lightweight, water-repellent product.

U.S. Pat. No. 6,319,312, to Luongo discloses the use of polyvinyl acetate emulsions to increase the strength of gypsum wallboard while reducing the weight of the gypsum wallboard. Luongo, however, teaches high concentrations of polyvinyl acetate emulsions—as much as 40 weight percent. The Luongo '312 patent also teaches that to help reduce the weight of the resultant wallboard, a lightweight mineral, especially perlite, is preferred as a substitute for some portion of the calcium sulfate.

U.S. Pat. No. 6,340,388, also to Luongo, likewise discloses the use of polyvinyl acetate emulsions to increase the strength of gypsum wallboard while reducing the weight of the gypsum wallboard. The Luongo '388 patent, however, teaches that supplemental polyvinyl alcohol must be included in addition to the polyvinyl acetate emulsions. Additionally, the Luongo '388 patent further teaches that the strength and weight of such wallboard compositions are improved by replacing a portion of the calcium sulfate with perlite.

There remains a need, however, for an aqueous composition that is useful in forming a gypsum wallboard core that possesses superior strength to weight ratio without the additional steps of converting polyvinyl acetate to polyvinyl alcohol, placing the polyvinyl alcohol into solution, or replacing some portion of the calcium sulfate with a lighter-weight, more expensive mineral.

### SUMMARY OF THE INVENTION

Accordingly, in one aspect, the invention is an aqueous composition that is useful in forming a gypsum wallboard core possessing superior strength to weight ratio.

In another aspect, the invention is a sheet of gypsum wallboard having superior strength to weight ratio.

In a yet another aspect, the invention is a method of forming a gypsum slurry useful in forming a wallboard core having superior strength to weight ratio.

### BRIEF DESCRIPTION OF THE DRAWING

FIG. 1 is a schematic cross-section of a sheet of gypsum wallboard in accordance with the present invention.

### DETAILED DESCRIPTION

In one aspect, the invention is an aqueous composition that is useful in forming a gypsum wallboard core possessing superior strength to weight ratio. In one embodiment, the composition includes calcium sulfate, water, and up to about 1.0 weight percent of a polyvinyl acetate emulsion. The emulsion preferably includes less than about six weight percent polyvinyl alcohol and the aqueous composition is preferably substantially free of supplemental polyvinyl alcohol.

Unexpectedly, it has been found that when high concentrations of polyvinyl acetate emulsions were added to the compositions of the present invention (i.e., amounts greater than about one weight percent) the resultant gypsum wallboard suffered from several problems. For example, wallboard having high concentrations of polyvinyl acetate emulsions had lower degrees of crystallinity and higher thermoplastic concentrations. As a result, the boards suffered from poor snappability (i.e., poor cutting). Additionally, high concentrations of polyvinyl acetate result in less strength enhancement than lower concentrations of polyvinyl acetate.

High concentrations of polyvinyl acetate also result in slurries that are too thick to pump without adding additional water. Without being bound by theory, it is believed that the addition of more water would cause longer drying times and higher energy costs in the production of the desired wallboard.

As is known in the art, polyvinyl acetate is often provided in the form of an emulsion. As is known to one of ordinary skill in the art, polyvinyl acetate is often formed by in-situ polymerization in water and protected, for example, by polyvinyl alcohol in a colloidal form, (i.e., polymerization polyvinyl alcohol). Commercial polyvinyl acetate emulsions typically include up to about six parts polymerization polyvinyl alcohol and about 49 parts polyvinyl acetate in a solution that is 55 parts solid.

As used herein, the term “supplemental polyvinyl alcohol” refers to polyvinyl alcohol concentrations that are not a part of such commercial polyvinyl acetate emulsions (i.e., polyvinyl alcohol in addition to the six percent polymerization polyvinyl alcohol typically present in commercial polyvinyl acetate emulsions).

Without being bound by theory, it is believed that the strength enhancement provided by the addition of polyvinyl acetate may be magnified at high agitation levels. Stated differently, when the aqueous slurry is highly agitated during processing, the resultant wallboard has higher strength than wallboard formed from slurries including polyvinyl acetate that are only mildly agitated during processing. One explanation for this unexpected result is that uniform concentration of the slurry, resulting from the high agitation of the slurry during processing, leads to better crystal formation.

In another embodiment, the polyvinyl acetate is modified with n-methyl acrylamide functional groups to enhance its efficacy.

In yet another embodiment, the polyvinyl acetate emulsion is replaced with an additive selected from the group including neoprene, soy protein, or combinations thereof. Alternatively, these additives can be included in addition to the polyvinyl acetate emulsion.

Other dry ingredients can be included within the aqueous slurry. For instance, an accelerator can be used to control, within certain limits, the crystal growth rate and set time of the gypsum composition. Examples of suitable accelerators include ball mill accelerators and potassium sulfate. Other suitable accelerators include, for example, sodium hydroxide (NaOH), calcium oxide (CaO), calcium hydroxide (Ca(OH)₂), calcium chloride (CaCl₂), sodium carbonate (Na₂CO₃), finely ground gypsum, potash (i.e., any of several compounds containing potassium, especially soluble compounds such as potassium oxide, potassium chloride, and various potassium sulfates), and the like.

Retarders can also be used in conjunction with the composition of the present invention. Retarders are used to adjust the delay time of the setting reaction until the slurry has been formed into a sheet. Suitable retarders, in accordance with the present invention, are polymers, although phosphates, sodium salts, proteins, and the like are also acceptable. Preferably, the retarder, if used, is at least one of a sodium salt of polyacrylic acid, an acrylic acid sulfonic acid copolymer, an ammonium salt of an acrylic acid sulfonic acid copolymer, a sodium salt of an acrylic acid sulfonic acid copolymer, or a blend of an acrylic acid polymer with a sulfonic acid copolymer and salts thereof.

A paper pulp solution can also be included within the aqueous slurry of the present invention. A pulp solution, where used, includes water and paper fibers, and may also include an accelerator, such as accumer, a retarder, such as a phosphate, or both. The paper pulp solution can also include one or more additives that increase the fluidity of the slurry or, alternatively, reduce the water requirements of the slurry.

Other conventional additives that impart additional desirable properties or otherwise facilitate manufacturing include, for example: set accelerators, set retarders, recalcination inhibitors, binders, adhesives, dispersing aids, leveling or nonleveling agents, thickeners, defoamers, bactericdes, fungicides, pH adjusters, colorants, reinforcing materials (e.g., fiberglass), fire retardants, water repellents, fillers, and mixtures thereof. Those having ordinary skill in the art would be aware of appropriate amounts of these optional fillers that may be included in gypsum compositions. In practice, these additives are typically used in amounts of less than one part by weight per 100 parts by weight of stucco.

In still another embodiment, the aqueous composition includes, on a dry basis, at least about 95 weight percent calcium sulfate, between about 0.1 and 1.0 weight percent polyvinyl acetate, and less than about 0.2 weight percent polyvinyl alcohol. In this embodiment, the composition preferably includes more polyvinyl acetate than polyvinyl alcohol.

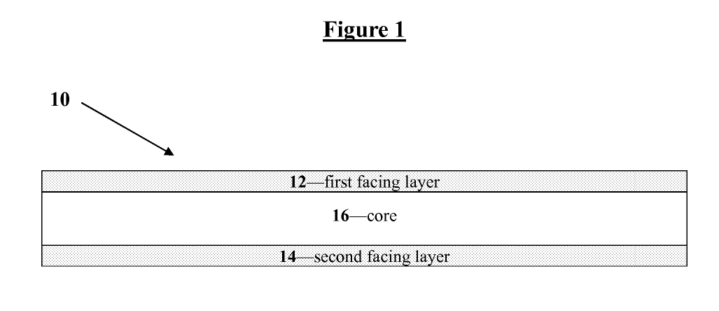

In another aspect depicted in FIG. 1, the invention is a sheet of gypsum wallboard 10 having a first facing layer 12, a second facing layer 14, and a core 16 positioned between the first 12 and second 14 facing layers. In one embodiment, the core 16 preferably includes, on a dry basis, at least about 95 weight percent calcium sulfate, and up to about 1.0 weight percent polyvinyl acetate. The core preferably includes less than about 0.2 weight percent polyvinyl alcohol, and typically includes less polyvinyl alcohol than polyvinyl acetate.

In a preferred embodiment, the first 12 and second 14 facing layers are paperboard. Those having ordinary skill in the art will recognize suitable paperboard materials that are appropriate for wallboard facing layers.

In another embodiment, the core 16 preferably includes, on a dry basis, at least about 98 weight percent calcium sulfate (e.g., 98.5-99.5), between about 0.1 and 1.0 weight percent polyvinyl acetate (e.g., 0.2-0.8), and between about 0 and 0.2 weight percent polyvinyl alcohol, if present. The polyvinyl acetate is typically present in the core 16 in an amount greater than the polyvinyl alcohol.

In yet another aspect, the invention is a method of forming a gypsum wallboard sheet that possesses superior strength to weight ratio. The method includes forming a gypsum slurry that includes water, calcium sulfate, and between about 0.1 and 1.0 weight percent polyvinyl acetate emulsion. In one embodiment, the gypsum slurry includes less than about 0.2 weight percent polyvinyl alcohol.

After the formation of the gypsum slurry, the method further includes continuously depositing the slurry onto a moving surface of a continuously fed bottom facing material. In one embodiment, the slurry is deposited such that the slurry forms a substantially planar upper surface even as a first and second edge of the bottom facing material remain uncovered by the gypsum slurry. As the gypsum slurry and bottom facing material advance, the first and second edges of the bottom facing material are folded up and onto the substantially planar upper surface of the gypsum slurry. A top facing material (i.e., backerboard) having two vertical adhesive lines is continuously fed onto the upper surface such that the glue lines cause the backerboard to be glued to the folded first and second edge of the bottom facing material.

In an alternative embodiment, a gypsum slurry that includes water, calcium sulfate, and between about 0.1 and 1.0 weight percent polyvinyl acetate emulsion is continuously deposited onto a moving surface of a continuously fed bottom facing material. The gypsum slurry preferably includes less polyvinyl alcohol than polyvinyl acetate and more preferably includes less than about 0.2 percent polyvinyl alcohol. The bottom facing material can be situated beneath a mold structure that forms a first and second edge on the slurry, wherein the first and second slurry edges are substantially perpendicular to the bottom facing material. After forming a substantially planar upper surface on the deposited gypsum slurry, the method includes folding, as the gypsum slurry and bottom facing material advance past the end of the mold, the first and second edges of the bottom facing material up and onto the upper surface of the gypsum slurry. A continuously fed top facing material (i.e., backerboard) having two vertical glue lines is then applied onto the upper surface of the gypsum slurry such that the glue adheres to the first and second folded edges.

It has been found that high concentrations of polyvinyl acetate emulsions may lead to processing problems. For example, at high concentrations, polyvinyl acetate may leak out of the board compositions as they are passed through the ovens and onto the rollers in the manufacturing facilities. This leakage may cause repeated production stoppages for cleaning.

Iron is often present in naturally occurring gypsum. Without being bound by theory, it is believed that the presence of even small amounts of iron in gypsum will reduce the efficacy of the polyvinyl acetate emulsion. Polyvinyl acetate and iron tend to complex with one another, thereby diminishing the strength enhancements that polyvinyl acetate appears to provide. Incorporating ethylene diamine tetraacetic acid (EDTA) may help overcome this problem, because EDTA forms complexes with iron faster than polyvinyl acetate, thereby preventing complexing of polyvinyl acetate and iron.

In describing the invention, it will be understood that a number of techniques are disclosed. Each of these has individual benefit, and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the specification and drawing, there have been disclosed typical embodiments of the invention and, although specific terms have been employed, they have been used in a generic and descriptive sense only and not for purposes of limitation, the scope of the invention being set forth in the following claims.

1. An aqueous composition that is useful in forming a gypsum wallboard core possessing superior strength to weight ratio, said aqueous composition comprising:
calcium sulfate;
up to about 1.0 weight percent of a polyvinyl acetate emulsion, said emulsion containing less than about 6 weight percent polyvinyl alcohol; and
water;
wherein said composition is substantially free of supplemental polyvinyl alcohol.

2. A composition according to claim 1, wherein said composition comprises, on a dry basis, at least about 95 weight percent calcium sulfate.

3. A composition according to claim 1, wherein said composition is substantially free of polyvinyl alcohol.

4. A composition according to claim 1, comprising on a dry basis:
at least about 95 weight percent calcium sulfate;
between about 0.1 and 1.0 weight percent of polyvinyl acetate; and
less than 0.2 weight percent polyvinyl alcohol, if any.

5. A composition according to claim 4, wherein said composition comprises, on a dry basis, at least about 98 weight percent calcium sulfate.

6. A sheet of gypsum wallboard, comprising:
a first facing layer;
a second facing layer; and
a core positioned between said first and second facing sheets, said core itself comprising on a dry basis:
at least about 95 weight percent calcium sulfate;
up to 1.0 weight percent polyvinyl acetate; and
less than 0.2 weight percent polyvinyl alcohol, if any.

7. A sheet of gypsum wallboard according to claim 6, wherein said first and second facing layers comprise paperboard.

8. A sheet of gypsum wallboard according to claim 6, wherein said core comprises, on a dry basis, at least about 98 weight percent calcium sulfate.

9. A sheet of gypsum wallboard according to claim 6, wherein said core is substantially free of supplemental polyvinyl alcohol.

10. A sheet of gypsum wallboard according to claim 6, wherein:
said first facing layer is a first paperboard facing sheet;
said second facing layer is a second paperboard facing sheet; and
said core comprises on a dry basis:
at least about 98 weight percent calcium sulfate;
between about 0.1 and 1.0 weight percent polyvinyl acetate; and
between 0 and about 0.2 weight percent polyvinyl alcohol, if any.

11. A method of forming a gypsum wallboard sheet that possesses superior strength to weight ratio, comprising:
forming a gypsum slurry that includes water, calcium sulfate, and between about 0.1 and 1.0 weight percent polyvinyl acetate emulsion, the gypsum slurry having less than about 0.2 weight percent polyvinyl alcohol;
continuously depositing the slurry onto a moving surface of a continuously fed bottom facing material such that a first and second edge of the bottom facing material remain uncovered by the gypsum slurry;
forming a substantially planar upper surface on the deposited gypsum slurry;
folding, as the gypsum slurry and bottom facing material advance, the first and second edges of the bottom facing material up and onto the upper surface so as to terminate on the upper surface; and
applying a continuously fed top facing material onto the upper surface.

12. A method of forming a gypsum wallboard sheet according to claim 11, wherein the step of forming a gypsum slurry comprises forming a gypsum slurry that includes, on a dry basis, at least about 95 weight percent calcium sulfate.

13. A method of forming a gypsum wallboard sheet according to claim 11, wherein the step of forming a gypsum slurry comprises forming a gypsum slurry that includes, on a dry basis, at least about 98 weight percent calcium sulfate.

14. A method of forming a gypsum wallboard sheet according to claim 11, wherein the step of forming a gypsum slurry comprises forming a gypsum slurry that is substantially free of polyvinyl alcohol.

15. A method of forming a gypsum wallboard sheet according to claim 11, wherein the step of forming a gypsum slurry comprises forming a gypsum slurry that is substantially free of supplemental polyvinyl alcohol.

16. A method of forming a gypsum wallboard sheet that possesses superior strength to weight ratio, comprising:
continuously depositing a gypsum slurry that includes water, calcium sulfate, and between about 0.1 and 1.0 weight percent polyvinyl acetate emulsion, the gypsum slurry having less than about 0.2 weight percent polyvinyl alcohol, onto a moving surface of a continuously fed bottom facing material, wherein the bottom facing material is beneath a mold structure that forms a first and second edge on the slurry, the first and second slurry edges being substantially perpendicular to the bottom facing material;
forming a substantially planar upper surface on the deposited gypsum slurry;
folding, as the gypsum slurry and bottom facing material advance past the end of the mold, the first and second edges of the bottom facing material up and onto the upper surface of the gypsum slurry so as to terminate on the upper surface; and
applying a continuously fed top facing material onto the upper surface.

17. A method of forming gypsum wallboard according to claim 16, wherein the step of continuously depositing a gypsum slurry comprises continuously depositing a gypsum slurry that includes, on a dry basis, at least about 95 weight percent calcium sulfate.

18. A method of forming gypsum wallboard according to claim 16, wherein the step of continuously depositing a gypsum slurry comprises continuously depositing a gypsum slurry that includes, on a dry basis, at least about 98 weight percent calcium sulfate.

19. A method of forming gypsum wallboard according to claim 16, wherein the step of continuously depositing a gypsum slurry comprises continuously depositing a gypsum slurry that is substantially free of supplemental polyvinyl alcohol.

20. A method of forming gypsum wallboard according to claim 16, wherein the step of continuously depositing a gypsum slurry comprises continuously depositing a gypsum slurry that is substantially free of polyvinyl alcohol.
